(19) United States
(12) Patent Application Publication
(10) Pub. No.: US 2025/0159586 A1
(43) Pub. Date: May 15, 2025

(54) INFORMATION TRANSMISSION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Yang SHEN, Beijing (CN)

(21) Appl. No.: 18/728,593

(22) PCT Filed: Jan. 14, 2022
(86) PCT No.: PCT/CN2022/072181

§ 371 Date: Jul. 12, 2024

(51) Int. Cl. H04W 48/04; H04W 24/02; H04W 60/04; H04W 60/06

(52) U.S. Cl. CPC H04W 48/04; H04W 24/02; H04W 60/04; H04W 60/06

(57) ABSTRACT

The embodiments of the present disclosure relate to an information transmission method and apparatus, and a communication device and a storage medium. The method comprises: a network slice admission control function (NSACF) determining, according to specific area indication information, statistical information of a user equipment (UE) registered in a specific area range based on a network slice.

### CROSS REFERENCE TO RELATED APPLICATIONS

The present application is a U.S. national phase of International Application No. PCT/CN2022/072181, filed on Jan. 14, 2022, the disclosure of which is incorporated herein by reference in its entirety.

### TECHNICAL FIELD

The present disclosure relates to but is not limited to the field of wireless communication technologies, and in particular to information transmission methods and apparatuses, a communication device, and a storage medium.

### BACKGROUND

A network slice can provide complete network functions, for example, radio access network functions, core network functions and Internet protocol multimedia subsystem (IMS) functions. A network can support one or more network slices. The network slices can provide different committed services and can be dedicated to specific users. Slices with the same service or slice but different slice differentiators may have different single network slice selection assistance information (S-NSSAI).

A mobile network operator (MNO) can deploy multiple network slices that provide the same function. The network slices can correspond to different user equipment (UE) groups, respectively. The network slices can provide different committed services and/or be dedicated to customers, respectively. Different network slices with the same slice function have different S-NSSAI, or service types of the network slices may be the same but the slice differentiators may be different.

### SUMMARY

According to a first aspect of the embodiments of the present disclosure, there is provided an information transmission method, performed by a network slice admission control function (NSACF). The method includes: determining statistical information of one or more user equipment (UE) registered within a specific area range based on one or more network slices according to specific area indication information.

According to a second aspect of the embodiments of the present disclosure, there is provided an information transmission method, performed by an access and mobility management function (AMF). The method includes: sending a statistical information update request, where the statistical information update request is configured to indicate a network slice admission control function (NSACF) to determine statistical information of one or more user equipment (UE) registered within a specific area range based on one or more network slices according to specific area indication information.

According to a third aspect of the embodiments of the present disclosure, there is provided a communication device, including a processor, a memory, and an executable program stored on the memory that can be run by the processor, where the processor performs the steps of the information transmission method as described in the first aspect or the second aspect when running the executable program.

According to a fourth aspect of the embodiments of the present disclosure, there is provided a storage medium on which an executable program is stored, where the steps of the information transmission method as described in the first aspect or the second aspect are implemented when the executable program is executed by a processor.

According to the information transmission methods, the communication device, and the storage medium provided in the embodiments of the present disclosure, the NSACF determines the statistical information of the UE registered within the specific area range based on the one or more network slices according to specific area indication information. In this way, compared to only determining statistical information of the entire network slice(s), the above solution can determine the statistical information of UEs registered within the specific area range based on the one or more network slices. The NSACF can obtain the statistical information of the specific area smaller than the granularity of the entire network slice(s), and manage network resources based on the statistical information within the specific area range, meeting requirements of refined management of network operations and services.

It should be understood that the general description above and the detailed description in the following text are only illustrative and explanatory, and cannot limit the embodiments of the present disclosure.

### BRIEF DESCRIPTION OF THE DRAWINGS

The accompanying drawings herein are incorporated into the specification and constitute a part of the specification, illustrate embodiments consistent with the present disclosure and together with the description, serve to explain the principles of the embodiments of the present disclosure.

FIG. 1 is a schematic structural diagram illustrating a wireless communication system according to an exemplary embodiment.

FIG. 2 is a flowchart illustrating an information transmission method according to an exemplary embodiment.

FIG. 3 is a flowchart illustrating another information transmission method according to an exemplary embodiment.

FIG. 4 is a flowchart illustrating yet another information transmission method according to an exemplary embodiment.

FIG. 5 is a flowchart illustrating yet another information transmission method according to an exemplary embodiment.

FIG. 6 is a flowchart illustrating yet another information transmission method according to an exemplary embodiment.

FIG. 7 is a flowchart illustrating yet another information transmission method according to an exemplary embodiment.

FIG. 8 is a flowchart illustrating yet another information transmission method according to an exemplary embodiment.

FIG. 9 is a flowchart illustrating yet another information transmission method according to an exemplary embodiment.

FIG. 10 is a block diagram illustrating an information transmission apparatus according to an exemplary embodiment.

FIG. 11 is a block diagram illustrating another information transmission apparatus according to an exemplary embodiment.

FIG. 12 is a block diagram illustrating an apparatus for information transmission according to an exemplary embodiment.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the present disclosure. Rather, they are merely examples of the apparatus and method consistent with some aspects of the present disclosure as detailed in the appended claims.

Terms used in the embodiments of the present disclosure are for the purpose of describing specific embodiments only, and are not intended to limit the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, etc. may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

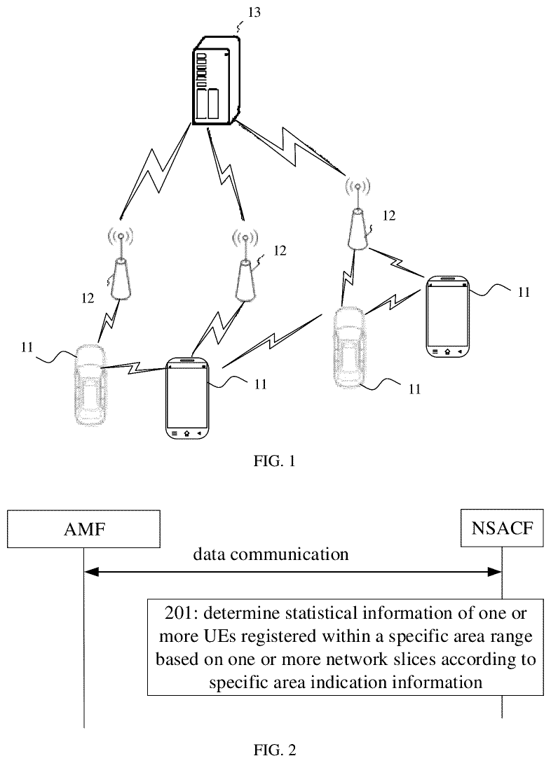

Referring to FIG. 1, FIG. 1 is a schematic structural diagram showing a wireless communication system provided in an embodiment of the present disclosure. As shown in FIG. 1, the wireless communication system is a communication system based on a cellular mobile communication technology, and may include several terminals 11 and several base stations 12.

The terminal 11 may be a device that provides voice and/or data connectivity to a user. The terminal 11 may communicate with one or more core networks via a radio access network (RAN). The terminal 11 may be an Internet of Things terminal, such as a sensor device, a mobile phone (or referred to as a “cellular” phone) and a computer with an Internet of Things terminal. For example, the terminal 11 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or a user equipment (UE). Or, the terminal 11 may be a device of an unmanned aerial vehicle. Or, the terminal 11 may be a vehicle-mounted device, for example, a driving computer with a wireless communication function, or a wireless communication device externally connected with a driving computer. Or, the terminal 11 may be a roadside device, such as a street lamp, a signal lamp or other roadside devices with a wireless communication function.

The base station 12 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be a next generation system of the 5G system. The access network in the 5G system may be referred to as a new generation-radio access network (NG-RAN), or a machine type communication (MTC) system.

The base station 12 may be an evolved base station (eNB) used in the 4G system. Or, the base station 12 may be a centralized distributed architecture base station (gNB) used in the 5G system. When the base station 12 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 12 is not limited in the embodiments of the present disclosure.

A wireless connection may be established between the base station 12 and the terminal 11 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between the terminals 11, for example, a vehicle to vehicle (V2V) communication, a vehicle to infrastructure (V2I) communication and a vehicle to pedestrian (V2P) communication in a vehicle to everything (V2X) communication.

In some embodiments, the wireless communication system may further include a network management device 13.

Several base stations 12 are connected to the network management device 13, respectively. The network management device 13 may be a core network device in the wireless communication system, such as access and mobility management function (AMF), session management function (SMF), user plane function (UPF), policy control function (PCF), network repository function (NRF). The implementation form of the network management device 13 is not limited in the embodiments of the present disclosure.

Execution subjects involved in the embodiments of the present disclosure include but are not limited to: mobile phone terminals in a cellular mobile communication system, network side devices, for example, access network devices such as base stations, and core networks.

Application function (AF)/or application service provider (ASP) needs to obtain statistical information of a network slice based on requirements of user experience guarantee or improvement. The statistical information includes a number of registered users in the network slice, a number of activated protocol data unit (PDU) sessions, the proportion of the registered users and/or activated PCU sessions in the network slice to an overall threshold of the network slice, etc.

In related technologies, the statistical information for a network slice is based on the granularity of the entire network slice(s), that is, the statistical information is information of the coverage range of the entire network slice(s). The statistical information based on the entire network slice(s) often cannot truly meet needs of operators and services, especially service characteristics requirements in specific scenarios. Thus, resources cannot be configured according to network status to improve the service experience of users.

For example, an operator generally have a capability to flexibly allocate resources and guarantee service quality of service (QoS) for a specific area within one or more network slices, such as one or more provinces, cities, specific venues, and schools. The operator needs to obtain specific statistical data such as the number of registered users in the specific area, so as to obtain and monitor real-time network conditions in the area. However, related technologies cannot meet the needs of the operator for statistical data.

Therefore, how to count, perceive, and monitor a number of registered users in a specific area of one or more network slices to meet operation and service needs in the specific area is an urgent problem that needs to be solved.

As shown in FIG. 2, this exemplary embodiment provides an information transmission method that can be performed by a network slice admission control function (NSACF) of a cellular mobile communication system. The method includes step 201.

In step 201, statistical information of one or more user equipment (UE) registered within a specific area range based on one or more network slices is determined according to specific area indication information.

The NSACF can be used to manage the registered UEs and PDU sessions in the one or more network slices, for example, to control the number of the registered UEs in the network slice. The NSACF can be an only NSACF deployed in the network slices, or the NSACF can be one or more of a plurality of NSACFs deployed in the network slices.

In practical applications, a plurality of NSACFs may be deployed in an operator network. An NSACF may serve one or more network slices in a service area. In a service area, a network slice is processed by only one NSACF. Herein, different network slices have different single network slice selection assistance information (S-NSSAI). The NSACF can be an NSACF instance or a NSACF set. A public land mobile network (PLMN) can have one or more service areas.

The specific area indication information can be used to indicate the specific area.

In one embodiment, network resources of the specific area are less than network resources of the entire network slice(s). That is, the specific area is smaller than the coverage range of the entire network slice resource.

For example, the one or more network slices can include N service areas, and the specific area can be one or M of the N service areas, where M is smaller than N, and M and N are positive integers.

The statistical information can be a statistical result of the NSACF on UEs registered within the specific area range of the network slices. For example, the statistical information may include but is not limited to at least one of the following information: types of UEs registered within the specific area range, proportions of different types of UEs registered within the specific area range, and a number of UEs registered within the specific area range.

In one embodiment, the statistical information includes the number of the UEs registered within the specific area range.

The NSACF can count the number of the UEs registered within the specific area range of the network slices. The NSACF can allocate corresponding resources based on the determined number of the UEs. The NSACF can also control the UEs registered within the specific area range of the network slices, for example, the NSACF adjusts the number of the UEs registered within the specific area range of the network slices. Thus, the capability to flexibly allocate resources within the specific area range can be improved, thereby improving the quality of service (QoS).

The NSACF can trigger network slice admission control (NSAC) based on an external trigger mechanism. The NSAC can include determining the statistical information of the UEs registered within the specific area range.

In the network slices, different UEs can exist in the form of different users. Different users can have different identifiers (IDs), such as UE IDs. The statistical information of the registered UEs can also be referred to as statistical information of registered users. For example, the number of the UEs registered within the specific area range can be determined based on UE IDs of UEs registered within the specific area range.

In this way, compared to only determining statistical information of the entire network slice(s), the above solution can determine statistical information of UEs registered within a specific area range based on one or more network slices. The NSACF can obtain the statistical information of the specific area smaller than the granularity of the entire network slice(s), and manage network resources based on the statistical information within the specific area range, meeting requirements of refined management of network operations and services.

In one embodiment, the specific area indication information includes at least one of the following:
a cell identifier (ID);
a tracking area ID (TAI);
an ID of an area of interest (AoI);
a TAI list;
an ID of a service area; or
an ID of a geography area.

Herein, there may be one or more cell IDs, TAIs, IDs of AoI, TAI lists, IDs of service area, and/or IDs of geography area. For example, the specific area indication information may include a plurality of cell IDs for indicating a plurality of cells.

The geography area indicated by the ID of geography area can be a geography area that can be mapped to the service area, so the NSACF can determine the statistical information based on the mapped service area.

The NSACF can determine the statistical information of the registered UE within the specific area range based on the specific area indication information. UE information statistics of smaller granularity than the entire network slice(s) are realized, and requirements of refined management of network operations and services are satisfied.

In one embodiment,
the specific area indication information is pre-stored in the NSACF;
or
the specific area indication information is determined based on a communication protocol;
or
the specific area indication information is received from a consumer network function.

The specific area indication information can be pre-stored in the NSACF. When the NSACF is triggered, the specific area can be determined by the pre-stored specific area indication information.

The specific area indication information can also be determined based on the communication protocol. When the NSACF is triggered, the specific area can be determined through the communication protocol or a calculation method provided in the communication protocol.

The consumer network function (NF) can include: network exposure function (NEF), policy decision function (PCF), operation administration and maintenance (OAM) and/or a primary NSACF in a multi-NSACF deployment scenario.

The consumer network function can determine a specific area based on its own needs, and can indicate the specific area to the NSACF through the specific area indication information.

In one embodiment, the method further includes:
the statistical information is sent to an access and mobility management function (AMF).

After determining the statistical information, the NSACF can feed back the statistical information to the AMF for reference in decision-making. For example, the AMF can determine whether a new UE can be added to the specific area based on whether the number of the UEs registered within the specific area range exceeds a predetermined threshold.

In one embodiment, the statistical information of the UEs registered within the specific area range based on the network slices is determined, including:
in response to receiving a statistical information update request from an AMF, the statistical information of the UEs registered within the specific area range based on the network slices is determined.

The NSACF determines the statistical information of the UEs registered within the specific area range based on the network slices, which can be triggered by the AMF or other network entities. If triggered by the AMF, the statistical information update request is sent by the AMF to the NSACF based on a UE registration event, or a UE de-registration event, or an updating UE configuration event. The statistical information update request is used to trigger the NSACF to execute NSAC and determine the statistical information.

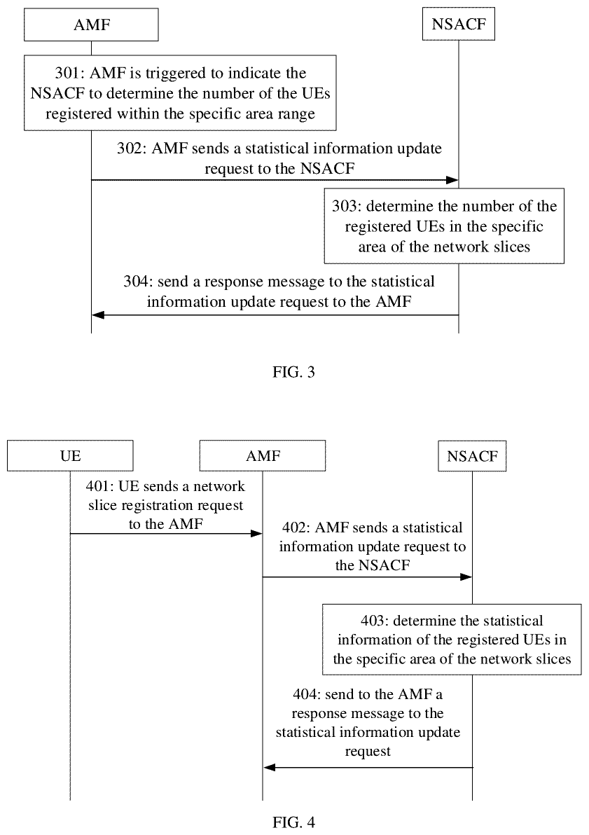

As shown in FIG. 3, the statistical information of the UEs registered within the specific area range being the number of the UEs registered within the specific area range of the network slices is taken an example for illustration. The NSACF determines the number of the UEs registered within the specific area range of the network slices according to the indication of the AMF through the statistical information update request, including:

Step 302: the NSACF receives the statistical information update request from the AMF, which triggers the NSACF to determine the number of the UEs registered within the specific area of the network slices. For example, the statistical information update request can be Nnsacf_NSAC_NumOfUEsUpdate_Request. The statistical information update request is received from the AMF, which is used to indicate the NSACF to perform a validity check and update process for the registered UEs in the specific area of the network slices.

Step 303: based on the statistical information update request, the NSACF performs a validity check and update process for the registered UEs in the specific area of the network slices, that is, determines the number of the registered UEs in the specific area of the network slices.

Step 304: the NSACF can send a response message to the statistical information update request to the AMF, indicating to the AMF the determined number of the registered UEs in the specific area, etc. For example, the response message to the statistical information update request can be Nnsacf_NSAC_NumOfUEsUpdate_Response.

When the statistical information of the UEs registered within the specific area range is other information, the invention concept and steps are similar to the above example of the number of the UEs registered within the specific area range of the network slices, which is not repeated herein.

In one embodiment, the statistical information update request is triggered by the AMF based on the following event: registering a UE with the network slices.

When a UE registration operation for one or more network slices occurs, the AMF can first determine the network slices corresponding to the registration operation and send a statistical information update request to the network slices corresponding to the registration operation.

The statistical information update request can explicitly or implicitly indicate an increase in the number of UEs. For example, when a UE registers to one or more network slices, the statistical update request can indicate an increase in the number of registered UEs with a predetermined bit, or a registration request of the UE can be used as the statistical information update request to implicitly indicate an increase in the number of registered UEs.

When performing the UE registration operation, the AMF can first perform discovery of the NSACF. The UE can trigger the AMF to initiate a statistical process of registered UEs in the specific area. The UE can indicate to AMF the slice IDs of the network slices for the registration operation. The AMF determines the network slices for registration operation based on the slice IDs, thereby determining the NSACF corresponding to the network slices. Subsequently, the AMF sends a statistical information update request to the determined NSACF of the network slices. The slices ID of network slices can include S-NSSAIs, and/or slice differentiators, etc.

The statistical information update request can be carried in operation information of the operation for the network slices. For example, when the UE registers to the network slices, the statistical information update request can be carried in the registration request.

The registration of the UE to the network slices can include an initial registration of the UE to the network slices, a registration of a mobile registration update type caused by the UE being handed over between AMFs, and the like.

The registration of the UE to the network slices will cause a change in statistical information of registered UEs in the specific area. Therefore, the AMF can indicate the NSACF to determine the statistical information of the registered UEs in the specific area.

For example, for the scenario where the UE registers to the network slices, the NSACF can determine statistical information of registered UEs in the specific area before the UE registers to the network slices, and can also determine statistical information of registered UEs in the specific area after the UE registers to the network slices.

As shown in FIG. 4, during the process of the UE registering with the network slices, the NSACF determining the statistical information of the registered UEs in the specific area can include:
Step 402: the NSACF receives a statistical information update request from the AMF, for example, N nsacf_NSAC_NumOfUEsUpdate_Request, which is used to trigger the NSACF to determine the statistical information of the registered UEs in the specific area of the network slices. The statistical information update request can explicitly or implicitly indicate to the NSACF the registration of the UE to the network slices.

In the embodiment of the present disclosure, the statistical information update request is generated by the AMF based on the registration request for the network slices sent by the UE. The registration request for the network slices is a registration process initiated by the UE to a certain network slice or some network slices. The AMF can perform the discovery and selection of NSACF based on parameters such as slice ID and NSACF characteristics, determine the network slices to which the UE needs to register, and trigger the validity check and update process of the number of registered users in the specific area. When the UE initiates the registration process of registering to the network slices, S-NSSAIs of the network slices requested to be registered can be carried in the registration request sent by the UE. The AMF can first determine whether the S-NSSAIs exists in allowed NSSAI. If so, step 402 is executed to request the NSACF to determine statistical information of registered UEs in the specific area. Otherwise, the registration of the UE can be refused. The statistical information update request can include identification information of the UE such as UE ID, access type, S-NSSAIs of the network slices where NSAC is requested, AMF ID, and update flag. The S-NSSAIs of the network slices where NSAC is requested can be one or more. The UE can request to register a plurality of network slices at the same time. The update flag can be used to indicate that the UE is added in the network slices, that is, the UE registers to the network slices.

In one embodiment, in response to the initial interaction between the AMF and the NSACF of the network slicse, a request to execute a NSAC process is made. For example, when a statistical information update request is sent to the network slices for the first time, the AMF can carry network function (NF) information of relevant endpoints that early admission control (EAC) needs to notify to in the statistical information update request, thereby implicitly subscribing to EAC-related notifications of the network slices from the NSACF, for example, whether the EAC is activated, etc.

Step 403: based on the statistical information update request, the NSACF performs a validity check and update process for the registered UEs in the specific area of the network slices, and determines the statistical information of the registered UEs in the specific area of the network slices, for example, the number of the registered UEs.

In response to the registration of the UE to the network slices, the NSACF updates the number of registered UEs in the network slices, and confirms the number of the registered UEs in the specific area of the network slices.

In one embodiment, the NSACF can determine whether to allow the registration of the UE based on the status of the network slices, for example, a load of network slices, the number of UEs already present in the network slices, etc.

Step 404: after determining the statistical information of the registered UEs in the specific area of the network slices, the NSACF sends to the AMF a response message to the statistical information update request. The response message can include the determined number of the registered UEs in the specific area, and/or a registration result of the UE, etc.

In one embodiment, the statistical information update request triggered by registering a UE with the network slices carries location information of the UE registered with the network slices.

The statistical information of the UEs registered within the specific area range based on the network slices is determined, including:

Based on the location information of the UE, it is determined whether to count the UE registered with the network slices in the statistical information.

The location information can be used to indicate the location of the UE requesting registration. If the location of the UE requesting registration corresponds to the specific area, the UE will be counted; otherwise, the UE will not be counted.

Herein, the location of the UE requesting registration corresponds to the specific area, including: the location of the UE requesting registration is within the specific area range, etc.

For example, in step 403 shown in FIG. 4, the UE may request registration to the network slices. Since the specific area range is only a part of the entire network slices(s), the location of the UE may be outside the specific area range. Therefore, when the NSACF determines the statistical information of the UEs registered within the specific area range, the UE may not be counted. If the UE is located within the specific area range, the UE needs to be counted.

Determining whether to count a UE based on its location information can improve the accuracy of the NSAC threshold in determining statistical information.

In one embodiment, the location information includes at least one of the following:
cell information; or
tracking area information.

The statistical information update request carries the location information of the registered user (UE), which is at least one of the following information: cell information, tracking area information.

In one embodiment, the location information of the UE registered with the network slices can be sent by a base station (for example, gNB) to the AMF. Then the AMF sends the location information to the NSACF. Or, the location information of the UE registered with the network slices can be obtained by the AMF from a gateway mobile location center (GMLC).

In one embodiment, the statistical information of the UEs registered within the specific area range based on the network slices is determined, including:
in response to an early admission control (EAC) being activated, the statistical information is determined before the UE registers with the network slices;
in response to the EAC not being activated, the statistical information is determined after the UE registers with the network slices.

The EAC can be a security check before the NSACF performs complete authentication. If the EAC is activated and the NSACF receives a statistical information update request, it can be determined that the EAC has been completed and the statistical information update request is credible. Therefore, the statistical information can be determined before the registration operation. Otherwise, the NSACF needs to perform authentication and other checks. The NSACF can determine the statistical information after the registration operation, which can improve the work efficiency of the NSACF.

In one embodiment, the statistical information update request is triggered by the AMF based on at least one of the following events: registering a UE with the network slices; or de-registering a UE from the network slices.

The de-registration of the UE may be initiated by the UE or the network. After the UE de-registers from the network slices, the AMF can send a statistical information update request to the NSACF to indicate the NSACF to determine the statistical information.

The statistical information update request can explicitly or implicitly indicate a decrease in the number of UEs. When the de-registration of the UE is performed, the UE or network can trigger the AMF to initiate a statistical process of registered UEs in the specific area. The UE or network can indicate to the AMF the slice identifiers of the network slices for the de-registration operation. The AMF determines the network slices for the de-registration operation based on the slice identifiers, and then sends a statistical information update request to the determined network slices. The slice identifiers of the network slices can include S-NSSAIs, and/or slice differentiators, etc.

The de-registration of the UE from the network slices can cause a change in the statistical information of registered UEs in the specific area. Therefore, the AMF can indicate the NSACF to determine the statistical information of registered UEs in the specific area.

As an example, the NSACF can determine the statistical information of the registered UEs in the specific area after the UE de-registers from the network slices.

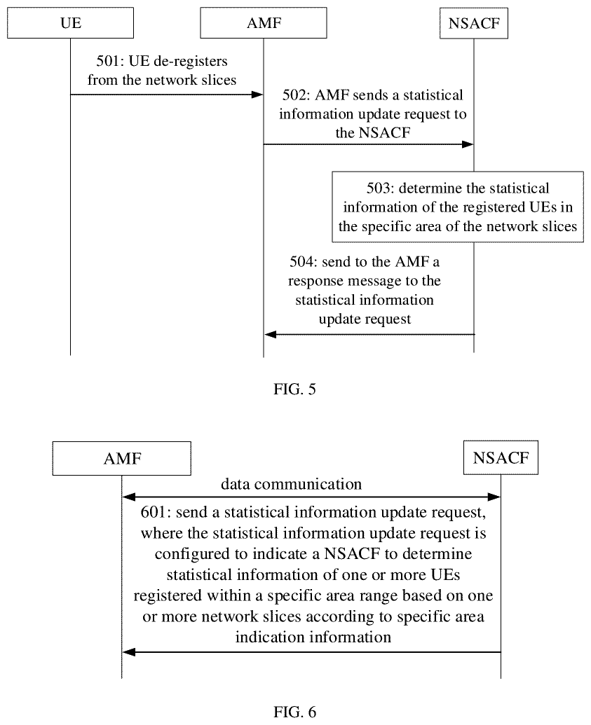

As shown in FIG. 5, during the process of the de-registration of the UE from the network slices, the NSACF determining the statistical information of the registered UEs in the specific area can include:

Step 502: the NSACF receives a statistical information update request sent by the AMF, for example, N nsacf_NSAC_NumOfUEsUpdate_Request, which is used to trigger the NSACF to determine the statistical information of the registered UEs in the specific area of the network slices. The statistical information update request can explicitly or implicitly indicate to the NSACF that the number of UEs has changed due to the de-registration of the UE. In one possible implementation, the statistical information update request is determined by the AMF based on the de-registration of the UE from the network slices. In one possible implementation, the AMF can send to the UE an indication message indicating successful de-registration. During the de-registration process, the AMF can determine the network slices which the UE de-registers from, and trigger the NSACF to initiate a validity check and update process of the number of registered users in the specific area.

The statistical information update request can include identification information of the UE such as UE ID, access type, S-NSSAIs of the network slices where NSAC is requested, AMF ID, and update flag. The update flag can be used to indicate a decrease in the number of UEs, that is, the UE de-registers from the network slices.

Step 503: based on the statistical information update request, the NSACF performs a validity check and update process for the registered UEs in the specific area of the network slices, and determines the statistical information of the registered UEs in the specific area, for example, the number of the registered UEs.

In response to the de-registration of the UE from the network slices, the NSACF updates the number of registered UEs in the network slices, and confirms the number of the registered UEs in the specific area of the network slices.

Step 504: after determining the statistical information of the registered UEs in the specific area of the network slices, the NSACF sends to the AMF a response message to the statistical information update request. The response message can include the determined number of the registered UEs in the specific area, etc.

In one embodiment, the statistical information update request is triggered by the AMF based on the following event: updating UE configuration based on the network slices.

The UE configuration can include network slice configuration associated with the UE on a network side. For example, a network slice-specific authentication and authorization (NSSAA) process or a change in a signing S-NSSAI process can trigger UE configuration update.

When the UE configuration is updated, the number of UEs within the network slices will change. Therefore, the NSACF can determine the statistical information of UEs registered within the specific area range.

When UE configuration is updated, the NSACF can receive a statistical information update request sent by AMF, and determines the statistical information of the UEs registered within the specific area range. The NSACF can send the statistical information to the AMF.

In one embodiment, the statistical information of the UEs registered within the specific area range based on the network slices is determined, including:
in response to the EAC being activated, the statistical information is determined before the UE configuration is updated;
in response to the EAC not being activated, the statistical information is determined after the UE configuration is updated.

The EAC can be a security check before the NSACF performs complete authentication. If the EAC is activated and the NSACF receives a statistical information update request, it can be determined that the EAC has been completed and the statistical information update request is credible. Therefore, the statistical information can be determined before the UE configuration is updated. Otherwise, the NSACF needs to perform authentication and other checks. The NSACF can determine the statistical information after the UE configuration is updated.

For example, if the EAC mode is activated and the update flag is increase in the number, the NSAC will be executed before receiving a message of updating UE configuration. If the EAC mode is activated but the update flag is reduce in the number, or the EAC mode is not activated, the NSAC is executed after receiving a message of updating UE configuration. Herein, the executed NSAC includes determining the statistical information of the UEs registered within the specific area range of the network slices.

In one embodiment, the statistical information update request carries one or more slice identifiers.

The statistical information of the UEs registered within the specific area range based on the network slices is determined, including:
the statistical information of the UEs registered within the specific area range based on the network slices indicated by the slice identifiers is determined.

The statistical information update request sent by the AMF received by the NSACF may carry the slice identifiers of the network slices for which statistical information needs to be determined. The slice identifiers may include S-NSSAIs, slice differentiators, etc.

The NSACF can determine the network slices for which statistical information needs to be determined based on the slice identifiers. Since the NSACF can correspond to a plurality of network slices, the accuracy of AMF indication can be improved by indicating the network slices through the slice identifiers.

In one embodiment, the specific area range of the network slices has a maximum number of registered users allowed to register a UE.

The NSACF can configure the maximum number of registered users registering a UE for the specific area, that is, the threshold for the maximum number of registered users allowed to register within the specific area range.

During the UE registration process, if the number of the registered UEs within the current specific area of the network slices reaches the maximum number of registered users, the NSACF can refuse the registration of the UE.

In one embodiment, if the number of the registered UEs within the current specific area of the network slices reaches the maximum number of registered users, and the location information of the UE registration belongs to the specific area, the NSACF can refuse the registration request of the UE.

In one embodiment, if numbers of registered UEs of all network slices that the UE requests to register reach maximum numbers of registered users corresponding to respective network slices, and there are default network slices in signing information of the network slices, the AMF can add one or more default network slices into allow NSSAI as network slices allowed by authorization. The UE may request to register to the default network slices allowed by authorization. If there is no default network slice in the signing information of the network slices, the AMF can refuse the registration request of the UE.

In one embodiment, the method further includes:
in response to the number of the UEs registered within the specific area range of the network slices reaching the maximum number of registered users, reaching maximum number indication information is sent to the AMF, where the reaching maximum number indication information is configured to indicate that the number of the UEs registered within the specific area range reaches the maximum number of registered users.

Herein, the number of the UEs registered within the specific area range reaches the maximum number of registered users, that is, the number of the UEs registered within the specific area range is equal to the maximum number of registered users.

During the UE registration process, if the number of the registered UEs within the current specific area of the network slices reaches the maximum number of registered users, and the location information of the UE registration belongs to the specific area, the NSACF can refuse the registration request of the UE, and indicate slice identifiers of the network slices to the AMF through the reaching maximum number indication information. The AMF can determine the reason for registration failure. At the same time, the reaching maximum number indication information can include statistical information of the network slices, that is, the number of registered UEs within the current network slices.

The UE can request to register a plurality of network slices through one or more registration requests. When one or more network slices refuse to register, the AMF can send indication information to the UE, indicating a list of slice identifiers of the network slices that refuse to register, and can indicate the reason of refusing to register for each network slice that refuses to register, for example, the number of registered UEs in the specific area of the network slices has reached the maximum number of registered users.

In one embodiment, the AMF can also set a timer that the UE can initiate a re-request to register one or more network slices. When the timer expires, the UE can initiate a registration request for the network slices again.

As shown in FIG. 6, this exemplary embodiment provides an information transmission method that can be performed by an AMF of a cellular mobile communication system. The method includes step 601.

In step 601, a statistical information update request is sent, where the statistical information update request is configured to indicate a network slice admission control function (NSACF) to determine statistical information of one or more user equipment (UE) registered within a specific area range based on one or more network slices according to specific area indication information.

A core network of the cellular mobile communication network, the AMF, is used to receive all connection and session related information from UEs and is responsible for handling connection and mobility management tasks.

The NSACF can be used to manage the registered UEs and PDU sessions in the one or more network slices, for example, to control the number of the registered UEs in the network slices. The NSACF can be an only NSACF deployed in the network slices, or the NSACF can be one or more of a plurality of NSACFs deployed in the network slices.

In practical applications, a plurality of NSACFs may be deployed in an operator network. An NSACF may serve one or more network slices in a service area. In a service area, a network slice is processed by only one NSACF. Herein, different network slices have different single network slice selection assistance information (S-NSSAI). The NSACF can be an NSACF instance or a NSACF set. A public land mobile network (PLMN) can have one or more service areas.

The specific area indication information can be used to indicate the specific area.

In one embodiment, network resources of the specific area are less than network resources of the entire network slice(s). That is, the specific area is smaller than the coverage range of the entire network slice resource.

For example, the one or more network slices can include N service areas, and the specific area can be one or M of the N service areas, where M is smaller than N, and M and N are positive integers.

The statistical information can be a statistical result of the NSACF on UEs registered within the specific area range of the network slices. For example, the statistical information may include at least one of the following information: types of UEs registered within the specific area range, proportions of different types of UEs registered within the specific area range, and a number of UEs registered within the specific area range.

In one embodiment, the statistical information includes the number of the UEs registered within the specific area range.

The NSACF can count the number of the UEs registered within the specific area range of the network slices. The NSACF can allocate corresponding resources based on the determined number of the UEs. The NSACF can also control the UEs registered within the specific area range of the network slices, for example, the NSACF adjusts the number of the UEs registered within the specific area range of the network slices. Thus, the capability to flexibly allocate resources within the specific area range can be improved, thereby improving the quality of service (QOS).

The NSACF can trigger network slice admission control (NSAC) based on an external trigger mechanism. The NSAC can include determining the statistical information of the UEs registered within the specific area range.

In the network slices, different UEs can exist in the form of different users. Different users can have different identifiers (IDs), such as UE IDs. The statistical information of the registered UEs can also be referred to as statistical information of registered users. For example, the number of the UEs registered within the specific area range can be determined based on UE IDs of UEs registered within the specific area range.

The NSACF determines the statistical information of UEs registered within the specific area range based on the network slices, which can be triggered by the AMF. The AMF can be triggered by events such as UE registration, sending a statistical information update request to the NSACF, triggering the NSACF to execute NSAC and determine the statistical information.

As shown in FIG. 3, the AMF indicates the NSACF to determine the number of the UEs registered within the specific area range of the network slices through the statistical information update request. The specific steps include:

Step 301: the AMF is triggered to indicate the NSACF to determine the number of the UEs registered within the specific area range, that is, the AMF is triggered to indicate the NSACF to perform a validity check and update process for registered UEs in the specific area of the network slices.

Step 302: the AMF sends a statistical information update request to the NSACF, which triggers the NSACF to determine the number of the registered UEs within the specific area of the network slices. For example, the statistical information update request can be Nnsacf_NSAC_NumOfUEsUpdate_Request. The statistical information update request is used to indicate the NSACF to perform a validity check and update process for the registered UEs in the specific area of the network slices based on the statistical information update request, to determine the number of the registered UEs in the specific area of the network slices.

Step 304: the AMF receives a response message to the statistical information update request sent by the NSACF, indicating to the AMF the determined number of the registered UEs in the specific area, etc. For example, the response message to the statistical information update request can be Nnsacf_NSAC_NumOfUEsUpdate_Response.

In this way, compared to only determining statistical information of the entire network slice(s), the above solution can determine statistical information of UEs registered within a specific area range based on one or more network slices. The NSACF can obtain the statistical information of the specific area smaller than the granularity of the entire network slice(s), and manage network resources based on the statistical information within the specific area, meeting requirements of refined management of network operations and services.

In some embodiments, the statistical information update request is triggered by the AMF based on at least one of the following events: registering a UE with the network slices; de-registering a UE from the network slices; or updating UE configuration based on the network slices.

In one embodiment, the specific area indication information includes at least one of the following:
a cell identifier (ID);
a tracking area ID (TAI);
an ID of an area of interest (AoI);
a TAI list;
an ID of a service area; or
an ID of a geography area.

Herein, there may be one or more cell IDs, TAIs, IDs of AoI, TAI lists, IDs of service area, and/or IDs of geography area. For example, the specific area indication information may include a plurality of cell IDs for indicating a plurality of cells.

The geography area indicated by the ID of geography area can be a geography area that can be mapped to the service area, so the NSACF can determine the statistical information based on the mapped service area.

The NSACF can determine the statistical information of the registered UE within the specific area range based on the specific area indication information. UE information statistics of smaller granularity than the entire network slice(s) are realized, and requirements of refined management of network operations and services are satisfied.

In one embodiment,
the specific area indication information is pre-stored in the NSACF;
or
the specific area indication information is determined based on a communication protocol;
or
the specific area indication information is received from a consumer network function.

The specific area indication information can be pre-stored in the NSACF. When the NSACF is triggered, the specific area can be determined by the pre-stored specific area indication information.

The specific area indication information can also be determined based on the communication protocol. When the NSACF is triggered, the specific area can be determined through the communication protocol or a calculation method provided in the communication protocol. The consumer network function can include: network exposure function (NEF), policy decision function (PCF), operation administration and maintenance (OAM) and/or a primary NSACF in a multi-NSACF deployment scenario.

The consumer network function can determine a specific area based on its own needs, and can indicate the specific area to the NSACF through the specific area indication information.

In one embodiment, the method further includes:
the statistical information sent by the NSACF is received.

After determining the statistical information, the NSACF can feed back the statistical information to the AMF for reference in decision-making. For example, the AMF can determine whether a new UE can be added to the specific area based on whether the number of the UEs registered within the specific area range exceeds a predetermined threshold.

In one embodiment, the statistical information update request is triggered by the AMF based on the following event: registering a UE with the network slices.

When a UE registration operation for one or more network slices occurs, the AMF can first determine the network slices corresponding to the registration operation and send a statistical information update request to the network slices corresponding to the registration operation.

The statistical information update request can explicitly or implicitly indicate an increase in the number of UEs. For example, when a UE registers to the network slices, the statistical update request can indicate an increase in the number of registered UEs with a predetermined bit, or a registration request of the UE can be used as the statistical information update request to implicitly indicate an increase in the number of registered UEs.

When performing the UE registration operation, the AMF can first perform discovery of the NSACF. The UE can trigger the AMF to initiate a statistical process of registered UEs in the specific area. The UE can indicate to AMF slice identifiers of the network slices for registration operation. The AMF determines the network slices for registration operation based on the slice identifiers, thereby determining the NSACF corresponding to the network slices. Subsequently, the AMF sends a statistical information update request to the determined NSACF of the network slices. The slice identifiers of the network slices can include S-NSSAIs, and/or slice differentiators, etc.

The statistical information update request can be carried in operation information of the operation for the network slices. For example, when the UE registers to the network slices, the statistical information update request can be carried in the registration request.

The registration of the UE to the network slices can include an initial registration of the UE to the network slices, a registration of a mobile registration update type caused by the UE being handed over between AMFs, and the like.

The registration of the UE to the network slices will cause a change in statistical information of registered UEs in the specific area. Therefore, the AMF can indicate the NSACF to determine the statistical information of the registered UEs in the specific area.

For example, for the scenario where a UE registers to the network slices, the NSACF can determine statistical information of registered UEs in the specific area before the UE registers to the network slices, and can also determine statistical information of registered UEs in the specific area after the UE registers to the network slices.

As shown in FIG. 4, during the process of the UE registering with the network slices, the AMF triggering the NSACF to determine the statistical information of the registered UEs in the specific area can include:

Step 402: the AMF sends a statistical information update request to the NSACF, for example, N nsacf_NSAC_NumOfUEsUpdate_Request, which is used to trigger the NSACF to determine the statistical information of the registered UEs in the specific area of the network slices. The statistical information update request can explicitly or implicitly indicate to the NSACF the registration of the UE to the network slices.

In the embodiment of the present disclosure, the statistical information update request is generated by the AMF based on the registration request for the network slices sent by the UE. The registration request for the network slices is a registration process initiated by the UE to one or some network slices. The AMF can perform the discovery and selection of NSACF based on parameters such as slice identifier and NSACF characteristics, determine the network slices to which the UE needs to register, and trigger the validity check and update process of the number of registered users in the specific area. When the UE initiates the registration process of registering to the network slices, S-NSSAIs of the network slices requested to be registered can be carried in the registration request sent by the UE. The AMF can first determine whether the S-NSSAIs exists in allowed NSSAI. If so, step 402 is executed to request the NSACF to determine statistical information of registered UEs in the specific area. Otherwise, the registration of the UE can be refused.

The statistical information update request can include identification information of the UE such as UE ID, access type, S-NSSAIs of the network slices where NSAC is requested, AMF ID, and update flag. The S-NSSAIs of the network slices where NSAC is requested can be one or more. The UE can request to register a plurality of network slices at the same time. The update flag can be used to indicate that the UE is added in the network slices, that is, the UE registers to the network slices.

In one embodiment, in response to the initial interaction between the AMF and the NSACF of the network slices, a request to execute a NSAC process is made. For example, when a statistical information update request is sent to the network slices for the first time, the AMF can carry network function (NF) information of relevant endpoints that early admission control (EAC) needs to notify to in the statistical information update request, thereby implicitly subscribing to EAC-related notifications of the network slices from the NSACF, for example, whether the EAC is activated, etc. The statistical information update request is used to indicate the NSACF to perform a validity check and update process for the registered UEs in the specific area of the network slices based on the statistical information update request, and determine the statistical information of the registered UEs in the specific area of the network slices, for example, the number of the registered UEs.

In response to the registration of the UE to the network slices, the NSACF updates the number of registered UEs in the network slices, and confirms the number of the registered UEs in the specific area of the network slices.

In one embodiment, the NSACF can determine whether to allow the registration of the UE based on the status of the network slices, for example, a load of network slices, the number of UEs already present in the network slices, etc.

Step 404: the AMF receives a response message to the statistical information update request sent by the NSACF after determining the statistical information of the registered UEs in the specific area of the network slices. The response message can include the determined number of the registered UEs in the specific area, and/or a registration result of the UE, etc.

In one embodiment, the statistical information update request triggered by registering the UE with the network slices carries location information of the UE registered with the network slices.

The location information of the UE is used by the NSACF to determine whether to count the UE registered with the network slices in the statistical information.

The location information can be used to indicate the location of the UE requesting registration. If the location of the UE requesting registration corresponds to the specific area, the UE will be counted; otherwise, the UE will not be counted.

Herein, the location of the UE requesting registration corresponds to the specific area, including: the location of the UE requesting registration is within the specific area range, etc.

For example, in step 403 shown in FIG. 4, the UE may request registration to the network slice. Since the specific area range is only a part of the entire network slice(s), the location of the UE may be outside the specific area range. Therefore, when the NSACF determines the statistical information of the UEs registered within the specific area range, the UE may not be counted. If the UE is located within the specific area range, the UE needs to be counted.

Determining whether to count a UE based on its location information can improve the accuracy of the NSAC threshold in determining statistical information.

In one embodiment, the location information includes at least one of the following:
cell information; or
tracking area information.

The statistical information update request carries the location information of the registered user (UE), which is at least one of the following information: cell information, tracking area information.

In one embodiment,
the location information is received from a base station;
and/or,
the location information is obtained from a gateway mobile location center (GMLC).

For example, the base station can determine the location information of the UE through positioning and other methods. The location information of the UE registered with the network slices can be sent to the AMF by the base station (such as gNB), and then sent to the NSACF by the AMF. Or, the location information of the UE registered with the network slices can be obtained by the AMF from the GMLC.

In one embodiment, in response to an early admission control (EAC) being activated, the NSACF determines the statistical information before the UE registers with the network slices;
in response to the EAC not being activated, the NSACF determines the statistical information after the UE registers with the network slices.

The EAC can be a security check before the NSACF performs complete authentication. If the EAC is activated and the NSACF receives a statistical information update request, it can be determined that the EAC has been completed and the statistical information update request is credible. Therefore, the statistical information can be determined before the registration operation. Otherwise, the NSACF needs to perform authentication and other checks. The NSACF can determine the statistical information after the registration operation, which can improve the work efficiency of the NSACF.

In one embodiment, the AMF is triggered based on the following event: de-registering a UE from the network slices.

The de-registration of the UE may be initiated by the UE or the network. After the UE de-registers from the network slices, the AMF can send a statistical information update request to the NSACF to indicate the NSACF to determine the statistical information.

The statistical information update request can explicitly or implicitly indicate a decrease in the number of UEs. When the de-registration of the UE is performed, the UE or network can trigger the AMF to initiate a statistical process of registered UEs in the specific area. The UE or network can indicate to the AMF the slice identifiers of the network slices for the de-registration operation. The AMF determines the network slices for the de-registration operation based on the slice identifiers, and then sends a statistical information update request to the determined network slices. The slice identifiers of the network slices can include S-NSSAIs, and/or slice differentiators, etc.

The de-registration of the UE from the network slice can cause a change in the statistical information of registered UEs in the specific area. Therefore, the AMF can indicate the NSACF to determine the statistical information of registered UEs in the specific area.

As an example, the NSACF can determine the statistical information of the registered UEs in the specific area after the UE de-registers from the network slices.

As shown in FIG. 5, during the process of the de-registration of the UE from the network slices, the AMF triggers the NSACF to determine statistical information of registered UEs in the specific area can include:

Step 502: the AMF sends a statistical information update request to the NSACF, for example, N nsacf_NSAC_NumOfUEsUpdate_Request, which is used to trigger the NSACF to determine the statistical information of the registered UEs in the specific area of the network slices. The statistical information update request can explicitly or implicitly indicate to the NSACF that the number of UEs has changed due to the de-registration of the UE.

The statistical information update request can include identification information of the UE such as UE ID, access type, S-NSSAIs of the network slices where NSAC is requested, AMF ID, and update flag. The update flag can be used to indicate a decrease in the number of UEs, that is, the UE de-registers from the network slices. The statistical information update request is used to indicate the NSACF to perform a validity check and update process for the registered UEs in the specific area of the network slices based on the statistical information update request, and determine the statistical information of the registered UEs in the specific area, for example, the number of the registered UEs.

In response to the de-registration of the UE from the network slices, the NSACF updates the number of registered UEs in the network slices, and confirms the number of the registered UEs in the specific area of the network slices.

Step 504: the AMF receives a response message to the statistical information update request sent by the NSACF after determining the statistical information of the registered UEs in the specific area of the network slices. The response message can include the determined number of the registered UEs in the specific area, etc.

In one embodiment, the statistical information update request is triggered by the AMF based on the following event: updating UE configuration based on the network slices.

The UE configuration can include network slice configuration associated with the UE on a network side. For example, a network slice-specific authentication and authorization (NSSAA) process or a change in a signing S-NSSAI process can trigger UE configuration update.

When the UE configuration is updated, the number of UEs within the network slices will change. Therefore, the NSACF can determine the statistical information of UEs registered within the specific area range.

When UE configuration is updated, the AMF can send a statistical information update request to the NSACF, and the NSACF determines the statistical information of the UEs registered within the specific area range. The NSACF can send the statistical information to the AMF.

In one embodiment, in response to the EAC being activated, the NSACF determines the statistical information before the UE configuration is updated;
in response to the EAC not being activated, the NSACF determines the statistical information is determined after the UE configuration is updated.

The EAC can be a security check before the NSACF performs complete authentication. If the EAC is activated and the NSACF receives a statistical information update request, it can be determined that the EAC has been completed and the statistical information update request is credible. Therefore, the statistical information can be determined before the UE configuration is updated. Otherwise, the NSACF needs to perform authentication and other checks. The NSACF can determine the statistical information after the UE configuration is updated.

For example, if the EAC mode is activated and the update flag is increase in the number, the NSAC will be executed before receiving a message of updating UE configuration. If the EAC mode is activated but the update flag is reduce in the number, or the EAC mode is not activated, the NSAC is executed after receiving a message of updating UE configuration. Herein, the executed NSAC includes determining the statistical information of the UEs registered within the specific area range of the network slices.

In one embodiment, the statistical information update request carries one or more slice identifiers (IDs).

The statistical information update request is configured to indicate the NSACF to determine the statistical information of the UEs registered within the specific area range based on the network slices indicated by the slice IDs.

The statistical information update request sent by the AMF to the NSACF can carry slice identifiers of the network slices for which statistical information needs to be determined. The slice identifiers may include S-NSSAIs, slice differentiators, etc.

The NSACF can determine the network slices for which statistical information needs to be determined based on the slice identifiers. Since the NSACF can correspond to a plurality of network slices, the accuracy of AMF indication can be improved by indicating the network slices through the slice identifiers.

In one embodiment, the specific area range has a maximum number of registered users allowed to register a UE;

The method further includes:
reaching maximum number indication information is received, where the reaching maximum number indication information is configured to indicate that the number of the UEs registered within the specific area range reaches the maximum number of registered users.

Herein, the number of the UEs registered within the specific area range reaches the maximum number of registered users, that is, the number of the UEs registered within the specific area range is equal to the maximum number of registered users.

The NSACF can configure the maximum number of registered users registering a UE for the specific area, that is, the threshold for the maximum number of registered users allowed to register within the specific area range.

During the UE registration process, if the number of the registered UEs within the current specific area of the network slices reaches the maximum number of registered users, the NSACF can refuse the registration of the UE.

In one embodiment, if the number of the registered UEs within the current specific area of the network slices reaches the maximum number of registered users, and the location information of the UE registration belongs to the specific area, the NSACF can refuse the registration request of the UE.

In one embodiment, if numbers of registered UEs of all network slices that the UE requests to register reach maximum numbers of registered users corresponding to respective network slices, and there are default network slices in signing information of the network slices, the AMF can add one or more default network slices into allow NSSAI as network slices allowed by authorization. The UE may request to register to the default network slices allowed by authorization. If there is no default network slice in the signing information of the network slices, the AMF can refuse the registration request of the UE.

During the UE registration process, if the number of the registered UEs within the current specific area of the network slices reaches the maximum number of registered users, and the location information of the UE registration belongs to the specific area, the NSACF can refuse the registration request of the UE, and indicate slice identifiers of the network slices to the AMF through the reaching maximum number indication information. The AMF can determine the reason for registration failure. At the same time, the reaching maximum number indication information can include statistical information of the network slices, that is, the number of registered UEs within the current network slices.

In one embodiment, the method further includes:
indication information of the network slices indicating that the number of the UEs registered within the specific area range reaches the maximum number of registered users is sent to one or more UEs.

Herein, the number of the UEs registered within the specific area range reaches the maximum number of registered users, that is, the number of the UEs registered within the specific area range is equal to the maximum number of registered users.

The UE can request to register a plurality of network slices through one or more registration requests. When one or more network slices refuse to register, the AMF can send indication information to the UE, indicating a list of slice identifiers of the network slices that refuse to register, and can indicate the reason of refusing to register for each network slice that refuses to register, for example, the number of registered UEs in the specific area of the network slice has reached the maximum number of registered users.

In one embodiment, the AMF can also set a timer that the UE can initiate a re-request to register one or more network slices. When the timer expires, the UE can initiate a registration request for network slices again.

Three specific examples are provided below in combination with any of the above embodiments.

The statistical method for a number of registered users in a specific area of network slice(s) includes:
1. In the registration process, configuration update process, or de-registration process of the UE, the NSACF performs statistics on the number of registered users based on information on the specific area of the network slice(s), increasing or decreasing the number of registered users in the specific area of the network slice(s). The information on the specific area can be configured on the NSACF or provided to the NSACF by the consumer network function in the 5G network.
2. The information on the specific area includes at least one of the following: a cell ID, a tracking area ID (TAI), an ID of an area of interest (AoI), a TAI list, a service area, and a geography area that can be mapped to the service area.
3. The consumer network function can be network exposure function (NEF), policy decision function (PCF), or a primary NSACF in a multi-NSACF deployment scenario.
4. The NSACF performs statistics on the number of registered users within the specific area of the network slice(s) based on the location information of the registered user.
5. The location information of the registered user is at least one of the following information: cell information, tracking area information, etc.
6. The location information of the registered user is obtained from the AMF and carried to the NSACF in the request message sent by the AMF to the NSACF.
7. The location information of the registered user is obtained by the AMF from the gNB and carried in the request message sent by the gNB to the AMF; or obtained by the AMF from the GMLC.
8. After receiving the request message of updating the number of registered users of the network slice(s) from the AMF, the NSACF updates the number of the registered users of the specific area of network slice(s) which is requested for.
9. Based on location information of the user carried in the request message from the AMF, the NSACF updates the number of the registered users of the specific area of network slice(s) which is requested for.
10. The NSACF can be an only NSACF deployed in the network slice(s), or one or more of a plurality of NSACFs deployed in the network slice(s).
11. The NSACF has a maximum number of registered users allowed in the specific area of the network slice(s), or a threshold for registered users allowed in the specific area of the network slice(s).

When the number of registered users in the specific area of the network slice(s) reaches the maximum number of registered users or the allowed threshold, the response message sent by the NSACF to the AMF carries slice identifier(s) (for example, S-NSSAI(s)) indicating that the number of registered users (UEs) in the specific area of the network slice(s) has reached the set threshold/maximum value, and a result parameter indicating that the maximum value has been reached.

### EXAMPLE 1

This example provides a specific example of a validity check and update process for the number of registered users in a specific area of a network slice.

The validity check and update process for the number of registered users in the specific area of the network slice is an updating process (increase or decrease) of the number of registered terminal users in one or more specific areas of a network slice. The AMF configures which network slices need to perform the validity check and update.

The information on the specific area can be configured on the NSACF, or provided to the NSACF by the consumer network function in 5G network (for example, network exposure function (NEF), or policy decision function (PCF), or a primary NSACF in a multi-NSACF deployment scenario etc.), or configured to the NSACF through operation administration and maintenance (OAM).

The NSACF in this process is applicable to a scenario where the only NSACF is deployed in the network slice(s), or a scenario where the NSACF can be one or more of a plurality of NSACFs deployed in the network slice(s).

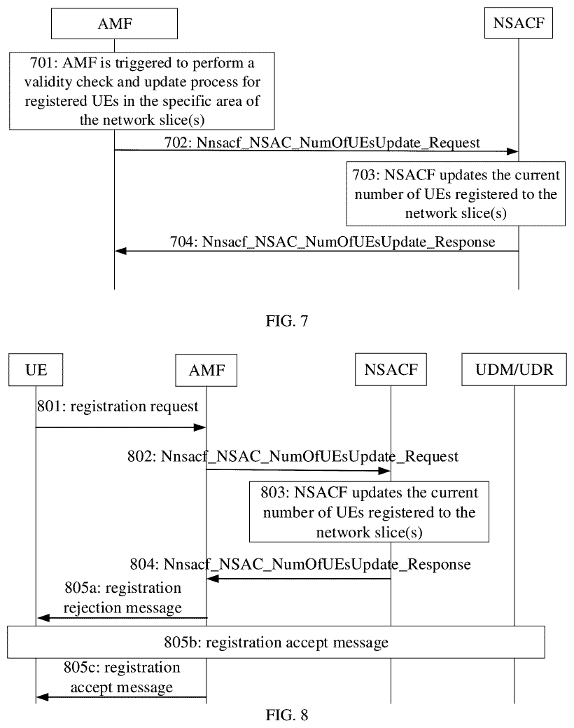

As shown in FIG. 7, the validity check and update process for the number of registered users in the specific area of network slice(s) includes:

Step 701: the AMF is triggered to perform a validity check and update process for registered UEs in the specific area of the network slice(s). If the AMF does not know the peer NSACF, the AMF first performs NSACF discovery and selection. When a certain network slice S-NSSAI needs to execute NSAC, and the slice identifier is in authorized NSSAI (for example, the AMF requests registration of the UE with the network slice) or is deleted from the authorized NSSAI (or example, the AMF requests de-registration of the UE from the network slice), the AMF triggers the validity check and update process of the network slice, and updates the number of registered terminal users. The triggering events of the process also include changes in the authorized NSAAI caused by switching across AMFs. There may be a plurality of NSACFs deployed within the network slice(s), and the AMF may interact with the plurality of NSACFs when performing the NSAC process for counting the number of registered users in the specific area of the network slice(s).

Herein, the information on the specific area of the network slice(s) performed by the NSACF can be at least one of the following information: a cell ID, a tracking area ID (TAI), an ID of an area of interest (AoI), a TAI list, a service area, and a geography area that can be mapped to the service area.

The AMF triggers the validity check and update process for registered UE in the specific area of the network slice(s) in the following situations:
a) In the registration process of the terminal, including an initial registration, a registration of a mobile registration update type caused by hand over between AMFs, based on whether the early admission control (EAC) mode is enabled, the NSAC is executed before or after receiving the registration accept message (for example, in the state of EAC activation, the NSAC process is executed before the registration accept message; when the EAC is not activated, the NSAC process is executed after receiving the registration accept message.
b) In the de-registration process, after the de-registration process is completed, the NSAC process is executed to subtract the UE from the statistics.
c) In the configuration update process of the terminal, for example, if a network slice-specific authentication and authorization (NSSAA) process or an S-NSSAI signing change process triggers a configuration update, the NSAC will be executed according to the EAC mode before receiving the configuration update message (for example, if the EAC mode is activated and the update flag is increase in the number, the NSAC will be executed before receiving the message of updating UE configuration; if the EAC mode is activated but the update flag is reduce in the number, or the EAC mode is not activated, the NSAC will be executed after receiving the message of updating UE configuration).

Step 702: the AMF sends the Nnsacf_NSAC_NumOfUEsUpdate_Request message to the NSACF. The AMF includes UE ID, access type, S-NSSAI(s) of the related network slice(s) where NSAC is requested, AMF ID, and update flag in the message. The update flag indicates whether the number of registered users (UEs) increases or decreases. For example, an increase is executed when a user registers to the network slice(s), and a decrease is executed when the UE de-registers from the network slice(s) or the registration cannot continue.

Optionally, the AMF also carries the location information of the registered user (UE) in the request message, which is at least one of the following information: cell information, tracking area information. The location information of the UE can be obtained by the AMF from the gNB and carried in the request message sent by the gNB to the AMF; or obtained by the AMF from the GMLC.

If this is the first interaction between the AMF and the NSACF for this network slice(s), and the NSAC process is executed, the AMF will carry network function (NF) information of relevant endpoints that the EAC needs to notify to in the message, thereby implicitly subscribing to EAC-related notifications of the network slice(s) from the NSACF.

Step 703: the NSACF updates the current number of UEs registered to the network slice(s). For example, based on the information provided by the AMF in the parameter such as the update flag, the number of registered UEs in the corresponding network slice(s) is increased or decreased. When the NSACF locally configures information on the specific area of the network slice(s), or receives information on the specific area of the network slice(s) provided by consumer NF (the consumer NF includes network exposure function (NEF), or policy decision function (PCF), or a primary NSACF in a multi-NSACF deployment scenario), or the information on the specific area of the network slice(s) is configured through an operation administration and maintenance (OAM) system, the NSACF updates the number of registered users for the requested specific area of the network slice(s). For example, based on the information provided by the AMF in the parameter such as the update flag, and/or based on the location information of the UE and the information on the specific area of the network slice(s), the number of registered UEs in the corresponding network slice(s) is increased or decreased.

Optionally, the NSACF is also configured with a maximum number of registered users allowed in the specific area of the network slice(s) or a threshold for registered users allowed in the specific area of the network slice(s). When the NSAC is executed for the specific area of the network slice(s), if the number of registered users in the specific area of the network slice(s) reaches the maximum number, the NSACF carries threshold reach information in the response message returned to the AMF.

If endpoints notified by the EAC are received from the AMF, the NSACF stores the endpoints notified by the EAC associated with S-NSSAI(s) for subsequent use of the stored notification endpoints to update the EAC mode.

Step 704: the NSACF returns a response message, Nnsacf_NSAC_NumOfUEsUpdate_Response, to the AMF, which carries slice identifier(s) (for example, S-NSSAI(s)) indicating that the number of registered users (UEs) in the specific area of the network slice(s) has reached the set threshold/maximum value, and a result parameter indicating that the maximum value has been reached.

In the UE registration process, if only some slices reach the maximum number of registered users, the AMF will send a registration accept message to the registered UE. In the message, the slice identifier(s) rejected due to NSAC is carried in a rejected slice list, and the corresponding rejection reason is set as the maximum number of users in the area of the network slice(s) has reached. Optionally, a timer that can initiate a re-request is set.

When all requested slices S-NSSAI(s) in a request message to the NSACF sent by the AMF have reached the maximum value allowed, and if one or more signed slices are marked as default slices in the signing information and NSAC does not need to be executed at the same time, the AMF may decide to place these default slices in allow NSSAI as slices allowed by authorization. Otherwise, the AMF will reject the registration request of the user UE. In the registration rejection message, the AMF carries a rejected slice (identifier) list, with a corresponding rejection reason value for each network slice, for example, the maximum number of registered users in the area of the network slice has reached. Optionally, a timer that can initiate a re-request is set.

Optionally, the NSAC is an execution process for a specific area of the network slice(s), and the response message returned in step 704 carries the threshold reach information within the specific area for AMF decision-making reference.

### EXAMPLE 2

As shown in FIG. 8, the specific steps of the validity check and update process for the number of registered users in a specific area of network slice(s) in registration of the UE to the network slice(s) include:
Step 801: the AMF receives a registration request from the UE. In the UE registration process, the user initiates a registration process with a certain network slice or certain network slices to the network, and the AMF performs the discovery and selection of the NSACF based on parameters such as slice identifier and NSACF characteristics. As described in step 701 of Example 1, the validity check and update process for the number of registered users in the specific area is triggered.

The specific content of steps 802 to 804 corresponds to steps 702 to 704 shown in FIG. 7 in Example 1, and will not be repeated herein.

Step 805a: if all slices requesting for NSAC have reached the maximum value (the maximum value is reached within the specific area, and there are no new threshold to update or supplement within the network slices or registration areas of the network slices), and based on AMF configuration and other policy information, for example, there are no other authorized default slices or slices in the network slice-specific authentication and authorization (NSSAA) process, the AMF will reject the UE from registering with the relevant network slice(s), send a registration rejection message, and carry the relevant rejection reason value, such as threshold reached, etc. Otherwise, step 805b is executed.

Step 805b: registration of the UE is performed in the network slice(s) and step 805c is executed.

Step 805c: if a regular registration process is performed in 805b, the AMF can send a registration accept message. If the UE simultaneously applies to register a plurality of network slices, some of which are successfully registered and some are not, the AMF sends the registration accept message to the UE, carrying one or more network slice identifiers and corresponding reason values for rejecting registration in the message. Optionally, it will carry a back-off timer for the UE to reselect and initiate registration.

### EXAMPLE 3

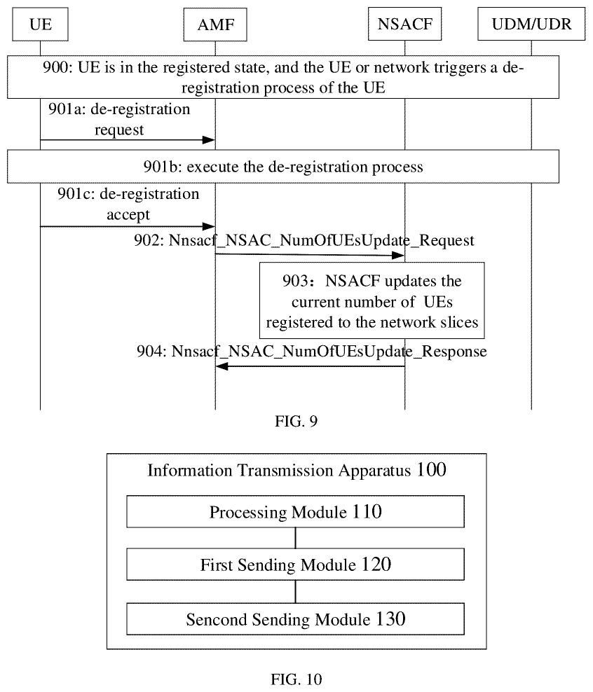

As shown in FIG. 9, the specific steps of the validity check and update process for the number of registered users in a specific area of the network slice(s) in de-registration of the UE from the network slice(s) include:
Step 900: the UE is in the registered state, and the UE or network triggers a de-registration process of the UE.
Steps 901a to 901c: the de-registration process is executed according to the conventional de-registration process. The de-registration process triggers the AMF to request the NSACF for the validity check and update process for the number of registered users in a specific area of the network slice.

The specific content of steps 902 to 904 corresponds to steps 702 to 704 shown in FIG. 7 in Example 1. After the de-registration process is completed, the AMF triggers the validity check and update process for the number of the registered users in the specific area of the network slice(s). The NSACF subtracts the number of the de-registered UE from the number of registered UEs in the specific area of each corresponding network slice, and deletes a UE ID of the de-registered UE from the list of registered users in each corresponding network slice.

The embodiments of the present disclosure also provide an information transmission apparatus, as shown in FIG. 10, applied in NSACF for cellular mobile wireless communication. The apparatus 100 includes:
a processing module 110, configured to determine statistical information of one or more user equipment (UE) registered within a specific area range based on one or more network slices according to specific area indication information.

In one embodiment, the statistical information includes a number of the UEs registered within the specific area range.

In one embodiment, the specific area indication information includes at least one of the following:
a cell identifier (ID);
a tracking area ID (TAI);
an ID of an area of interest (AoI);
a TAI list;
an ID of a service area; or
an ID of a geography area.

In one embodiment, the specific area indication information is pre-stored in the NSACF;
or
the specific area indication information is sent by a consumer network function to the NSACF.

In one embodiment, the processing module 110 is specifically configured to:
in response to receiving a statistical information update request of an access and mobility management function (AMF), determine the statistical information of the UEs registered within the specific area range based on the network slices.

In one embodiment, the statistical information update request is triggered by the AMF based on at least one of the following events:
registering a UE with the network slices;
de-registering a UE from the network slices; or
updating UE configuration based on the network slices.

In one embodiment, the statistical information update request triggered by registering the UE with the network slices carries location information of the UE registered with the network slices;
where determining the statistical information of the UEs registered within the specific area range based on the network slices includes:
determining whether to count the UE registered with the network slices in the statistical information based on the location information.

In one embodiment, the location information includes at least one of the following:
cell information; or
tracking area information.

In one embodiment, the statistical information update request carries one or more slice identifiers (IDs);
where the processing module 110, specifically configured to:
determine the statistical information of the UEs registered within the specific area range based on the network slices indicated by the slice IDs.

In one embodiment, the processing module 110 is specifically configured to:
in response to an early admission control (EAC) being activated, determine the statistical information before the UE registers with the network slices;
in response to the EAC being activated, determine the statistical information before the UE configuration is updated;
in response to the EAC not being activated, determine the statistical information after the UE registers with the network slices;
in response to the EAC not being activated, determine the statistical information after the UE configuration is updated.

In one embodiment, the apparatus 100 further includes:
a first sending module 120 configured to send the statistical information to the AMF.

In one embodiment, the specific area range of the network slices has a maximum number of registered users allowed to register a UE.

In one embodiment, the apparatus 100 further includes:
a second sending module 130, configured to, in response to a number of the UEs registered within the specific area range of the network slices reaching the maximum number of registered users, send reaching maximum number indication information indicating that the number of the UEs registered within the specific area range reaches the maximum number of registered users to an access and mobility management function (AMF).

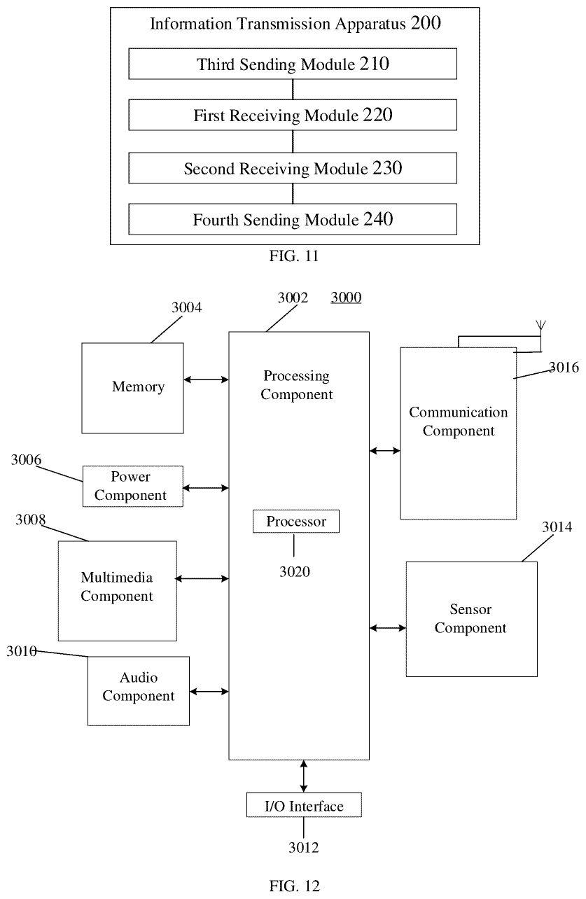

The embodiments of the present disclosure also provide an information transmission apparatus, as shown in FIG. 11, applied to AMF in cellular mobile wireless communication. The apparatus 200 includes:
a third sending module 210, configured to send a statistical information update request, where the statistical information update request is configured to indicate a network slice admission control function (NSACF) to determine statistical information of one or more user equipment (UE) registered within a specific area range based on one or more network slices according to specific area indication information.

In one embodiment, the statistical information includes a number of the UEs registered within the specific area range.

In one embodiment, the specific area indication information includes at least one of the following:
a cell identifier (ID);
a tracking area ID (TAI);
an ID of an area of interest (AoI);
a TAI list;
an ID of a service area; or
an ID of a geography area.

In one embodiment, the statistical information update request is triggered by the AMF based on at least one of the following events:
registering a UE with the network slices;
de-registering a UE from the network slices; or
updating UE configuration based on the network slices.

In one embodiment, the statistical information update request triggered by registering the UE with the network slices carries location information of the UE registered with the network slices;
where the location information is configured for the NSACF to determine whether to count the UE registered with the network slices in the statistical information.

In one embodiment, the location information includes at least one of the following:
cell information; or
tracking area information.

In one embodiment, the location information is received from a base station,
and/or,
the location information is obtained from a gateway mobile location center (GMLC).

In one embodiment, the statistical information update request carries one or more slice identifiers (IDs);
where the statistical information update request is configured to indicate the NSACF to determine the statistical information of the UEs registered within the specific area range based on the network slices indicated by the slice IDs.

In one embodiment, the apparatus 200 further includes:
a first receiving module 220 configured to receive the statistical information sent by NSACF.

In one embodiment, the specific area range has a maximum number of registered users allowed to register a UE; and
the apparatus further includes:
a second receiving module 230 configured to receive reaching maximum number indication information, where the reaching maximum number indication information is configured to indicate that the number of the UEs registered within the specific area range reaches the maximum number of registered users.

In one embodiment, the apparatus 200 further includes:
a fourth sending module 240 configured to send indication information of one or more network slices indicating that the number of the UEs registered within the specific area range reaches the maximum number of registered users to one or more UEs.

In exemplary embodiments, the processing module 110, the first sending module 120, the second sending module 130, the third sending module 210, the first receiving module 220, the second receiving module 230, and the fourth sending module 240 may be implemented by one or more central processing units (CPUs), graphics processing units (GPUs), baseband processors (BPs), application specific integrated circuits (ASICs), digital signal processors (DSPs), programmable logic devices (PLDs), complex programmable logic devices (CPLDs), field programmable gate array (FPGAs), universal processors, controllers, microcontrollers (MCUs), microprocessors, or other electronic components for performing the aforementioned methods.

FIG. 12 is a block diagram of an apparatus 3000 for information transmission according to an exemplary embodiment. For example, the apparatus 3000 may be a mobile phone, a computer, a digital broadcasting device, a messaging device, a game console, a tablet device, a medical device, a fitness device, a personal digital assistant, or the like.

Referring to FIG. 12, the apparatus 3000 can include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operations of the apparatus 3000, such as operations associated with display, telephone calls, data communications, camera operations, and recording operations. The processing component 3002 can include one or more processors 3020 to execute instructions to complete all or part of the steps of the above methods. In addition, the processing component 3002 can include one or more modules to facilitate interaction between the processing component 3002 and other components. For example, the processing component 3002 can include a multimedia module to facilitate interaction between the multimedia component 3008 and the processing component 3002.

The memory 3004 is configured to store various types of data to support operations at the apparatus 3000. Examples of such data include instructions for any application or method operating on the apparatus 3000, contact data, phone book data, messages, pictures, videos, and so on. The memory 3004 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power component 3006 provides power to various components of the apparatus 3000. The power component 3006 can include a power management system, one or more power sources, and other components associated with generating, managing, and distributing power for the apparatus 3000.

The multimedia component 3008 includes a screen that provides an output interface between the apparatus 3000 and a user. In some embodiments, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor can not only sense boundaries of a touch or swipe action, but also detect the duration and pressure related to the touch or swipe action. In some embodiments, the multimedia component 3008 includes a front camera and/or a rear camera. When the apparatus 3000 is in an operation mode, such as a shooting mode or a video mode, the front camera and/or the rear camera can receive external multimedia data. Each of the front and rear cameras can be a fixed optical lens system or have focal length and optical zooming capabilities.

The audio component 3010 is configured to output and/or input audio signals. For example, the audio component 3010 includes a microphone (MIC) that is configured to receive external audio signals when the apparatus 3000 is in an operation mode, such as a call mode, a recording mode, and a voice recognition mode. The received audio signals can be further stored in the memory 3004 or transmitted via the communication component 3016. In some embodiments, the audio component 3010 further includes a speaker for outputting audio signals.

The I/O interface 3012 provides an interface between the processing component 3002 and peripheral interface modules. The peripheral interface modules can be keyboards, a click wheels, a buttons, or the like. These buttons can include, but are not limited to, home button, volume button, start button, and lock button.

The sensor component 3014 includes one or more sensors for providing the apparatus 3000 with status assessment in various aspects. For example, the sensor component 3014 can detect an open/closed state of the apparatus 3000, relative positioning of components, such as the display and keypad of the apparatus 3000. The sensor component 3014 can also detect a change in position of the apparatus 3000 or a component of the apparatus 3000, the presence or absence of user contact with the apparatus 3000, orientation or acceleration/deceleration of the apparatus 3000, and temperature change of the apparatus 3000. The sensor component 3014 can include a proximity sensor configured to detect the presence of nearby objects without any physical contact. The sensor assembly 3014 can also include a light sensor, such as a Complementary Metal-Oxide-Semiconductor (CMOS) or Charged Coupled Device (CCD) image sensor, for use in imaging applications. In some embodiments, the sensor component 3014 can further include an acceleration sensor, a gyro sensor, a magnetic sensor, a pressure sensor, or a temperature sensor.

The communication component 3016 is configured to facilitate wired or wireless communication between the apparatus 3000 and other devices. The apparatus 3000 can access a wireless network based on a communication standard, such as Wi-Fi, 4G or 5G, or a combination thereof. an exemplary In embodiment, the communication component 3016 receives broadcast signals or broadcast-related information from an external broadcast management system via a broadcast channel. In one exemplary embodiment, the communication component 3016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the apparatus 3000 can be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for performing the above methods.

In an exemplary embodiment, there is also provided a non-transitory computer readable storage medium including executable instructions, such as the memory 3004 including executable instructions executable by the processor 320 of the apparatus 3000 to implement the above methods. For example, the non-transitory computer readable storage medium can be a ROM, a random access memory (RAM), a CD-ROM, a magnetic tape, a floppy disk, and an optical data storage device, etc.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the embodiments of the present disclosure. The specification and embodiments are exemplary only, with the true scope and spirit of the present disclosure being indicated by the following claims.

It should be understood that the present disclosure is not limited to the precise structure that has been described above and shown in the drawings, and various modifications and changes may be made without departing from the scope thereof. The scope of the present disclosure is limited only by the appended claims.

1. An information transmission method, performed by a network slice admission control function (NSACF), the method comprising:
determining statistical information of one or more user equipment (UE) registered within a specific area range based on one or more network slices according to specific area indication information.

2. The method according to claim 1, wherein the statistical information comprises a number of the UEs registered within the specific area range.

3. The method according to claim 1, further comprising at least one of:
the specific area indication information comprising at least one of:
a cell identifier (ID);
a tracking area ID (TAI);
an ID of an area of interest (AoI);
a TAI list;
an ID of a service area; or
an ID of a geography area; or
the specific area indication information being pre-stored in the NSACF, determined based on a communication protocol, or received from a consumer network function.

4. (canceled)

5. The method according to claim 1, wherein determining the statistical information of the UEs registered within the specific area range based on the network slices comprises:
receiving a statistical information update request of an access and mobility management function (AMF), and determining the statistical information of the UEs registered within the specific area range based on the network slices,
wherein the statistical information update request is triggered by the AMF based on at least one of:
registering a UE with the network slices;
de-registering a UE from the network slices; or
updating UE configuration based on the network slices.

6. (canceled)

7. The method according to claim 5, wherein the statistical information update request triggered by registering the UE with the network slices carries location information of the UE registered with the network slices;
wherein determining the statistical information of the UEs registered within the specific area range based on the network slices comprises:
determining whether to count the UE registered with the network slices in the statistical information based on the location information,
wherein the location information comprises at least one of cell information or tracking area information.

8. (canceled)

9. The method according to claim 5, wherein the statistical information update request carries one or more slice identifiers (IDs);
wherein determining the statistical information of the UEs registered within the specific area range based on the network slices comprises:
determining the statistical information of the UEs registered within the specific area range based on the network slices indicated by the slice IDs.

10. The method according to claim 5, wherein determining the statistical information of the UEs registered within the specific area range based on the network slices comprises one of:
determining the statistical information before the UE registers with the network slices, wherein an early admission control (EAC) is activated;
determining the statistical information before the UE configuration is updated, wherein the EAC is activated;
determining the statistical information after the UE registers with the network slices, wherein the EAC is not activated; or
determining the statistical information after the UE configuration is updated, wherein the EAC is not activated.

11. The method according to claim 1, further comprising:
sending the statistical information to an access and mobility management function (AMF).

12. The method according to claim 1, wherein the specific area range of the network slices has a maximum number of registered users allowed to register a UE:
wherein the method further comprises:
sending reaching maximum number indication information indicating that a number of the UEs registered within the specific area range reaches the maximum number of registered users to an access and mobility management function (AMF), wherein the number of the UEs registered within the specific area range of the network slices reaches the maximum number of registered users.

13. (canceled)

14. An information transmission method, performed by an access and mobility management function (AMF), the method comprising:
sending a statistical information update request, wherein the statistical information update request is configured to indicate a network slice admission control function (NSACF) to determine statistical information of one or more user equipment (UE) registered within a specific area range based on one or more network slices according to specific area indication information.

15. The method according to claim 14, wherein the statistical information comprises a number of the UEs registered within the specific area range.

16. (canceled)

17. The method according to claim 14, wherein the statistical information update request is triggered by the AMF based on at least one of:
registering a UE with the network slices;
de-registering a UE from the network slices; or
updating UE configuration based on the network slices.

18. The method according to claim 17, wherein the statistical information update request triggered by registering the UE with the network slices carries location information of the UE registered with the network slices;
wherein the location information is configured for the NSACF to determine whether to count the UE registered with the network slices in the statistical information;
wherein the location information comprises at least one of cell information or tracking area information;
wherein the location information is received from a base station or obtained from a gateway mobile location center (GMLC).

19. (canceled)

20. (canceled)

21. The method according to claim 14, wherein the statistical information update request carries one or more slice identifiers (IDs);
wherein the statistical information update request is configured to indicate the NSACF to determine the statistical information of the UEs registered within the specific area range based on the network slices indicated by the slice IDs.

22. The method according to claim 14, further comprising:
receiving the statistical information sent by the NSACF.

23. The method according to claim 14, wherein the specific area range has a maximum number of registered users allowed to register a UE; and
the method further comprises:
receiving reaching maximum number indication information, wherein the reaching maximum number indication information is configured to indicate that the number of the UEs registered within the specific area range reaches the maximum number of registered users; and
sending indication information of one or more network slices indicating that the number of the UEs registered within the specific area range reaches the maximum number of registered users to one or more UEs.

24.-26. (canceled)

27. A communication device, comprising:
a processor; and
a memory storing a program executable by the processor, wherein the processor performs:
determining statistical information of one or more user equipment (UE) registered within a specific area range based on one or more network slices according to specific area indication information.

28. A non-transitory storage medium having an executable program stored thereon, wherein when the executable program is executed by a processor, the processor is caused to perform the method according to claim 1.

29. A communication device, comprising:
a processor; and
a memory storing a program executable by the processor,
wherein the processor performs the method according to claim 14.

30. A non-transitory storage medium having an executable program stored thereon, wherein when the executable program is executed by a processor, the processor is caused to perform the method according to claim 14.
